(19) United States
(12) Patent Application Publication
(10) Pub. No.: US 2010/0273467 A1
(43) Pub. Date: Oct. 28, 2010

(54) METHOD FOR PROVIDING OF CALL TRANSFERRING SERVICE AND MOBILE TERMINAL USING THE SAME

(75) Inventors: Hyung Jin Kim, Daejeon (KR); Yun Hee Cho, Daejeon (KR); Ji Yeon Kim, Daejeon (KR); Seong Chul Cho, Daejeon (KR); Gweon Do Jo, Daejeon (KR); Jin Up Kim, Daejeon (KR)

Correspondence Address: RABIN & Berdo, PC, 1101 14TH STREET, NW, SUITE 500, WASHINGTON, DC, 20005, US

(73) Assignee: ELECTRONICS AND TELECOMMUNICATIONS RESEARCH INSTITUTE, Daejeon (KR)

(21) Appl. No.: 12/747,881

(22) PCT Filed: Jul. 29, 2008
(86) PCT No.: PCT/KR08/04408

§ 371 Date: Jun. 11, 2010

(30) Foreign Application Priority Data
Dec. 14, 2007 (KR) 10-2007-0131337

(51) Int. Cl. H04W 4/00

(52) U.S. Cl. 455/417

(57) ABSTRACT

A method of providing a call transfer service and a mobile terminal using the same are provided. When a call connection request signal transmitted to a mobile communication server through a PSTN is received, any one of previously stored phone numbers is selected and a service of transferring a call to the selected phone number according to the received call connection request signal is requested. Therefore, when call connection is requested, it is selected whether a call is to be transferred, when a call is transferred, a phone number to transfer a call can be dynamically selected according to a user situation, and thus user convenience according to call transfer can be improved.

### TECHNICAL FIELD

The present invention relates to a method of providing a call transfer service and a mobile terminal using the same, and more particularly, to a method of providing a call transfer service and a mobile terminal using the same that can provide a dynamic call transfer service according to a user request in a mobile communication system.

The present invention has obtained from a research for IT growth power technology development of Ministry of Information and Communication and Institute for Information Technology Advancement [subject management number: 2006-S-001-02, a subject title: adaptive wireless connecting and transmission technical development for 4th generation mobile communication].

### BACKGROUND ART

In general, a call transfer service allows, when a user previously sets a phone number for transferring a call to a terminal and a call signal is requested to the corresponding terminal, to automatically transfer a call to the preset phone number. Accordingly, even when the user does no longer want a call transfer service, as far as the call transfer service is not cancelled, the call transfer service is performed.

Accordingly, only when a call is requested from a specific number or a specific group, a function of performing a call transfer service was added. However, in this case, even when a call transfer service is sometimes unnecessary, as far as the call transfer service to the corresponding phone number or the corresponding group is not cancelled, the call transfer service is performed.

For example, when a call is requested from a specific phone number, the user intends to call to a phone number in which a call is requested. However, when a call transfer service is already set to the corresponding phone number, only after a call transfer service to the corresponding phone number is cancelled, when a call is requested from the corresponding phone number, communication can be connected.

That is, in a state where a call transfer service is already set, a method of temporarily canceling the call transfer service, or in a state where a call transfer service is not set, a method of temporarily performing the call transfer service is not suggested. Further, even when it is intended to change a phone number in which a call is transferred, in a state where call connection is already requested, a method of changing the call transfer phone number is not suggested.

### DISCLOSURE OF INVENTION

### Technical Problem

The present invention has been made in an effort to solve the above problems, and the present invention provides a method of providing a call transfer service and a mobile terminal using the same that can perform a dynamic call transfer service when call connection is requested and thus greatly improve user convenience.

### Technical Solution

According to an aspect of the present invention, there is provided a method of providing a call transfer service, including: receiving, by a mobile communication server, a call connection request signal; converting an operation mode to a call transfer mode and calling a stored predetermined phone number list; generating a call transfer request message including a selected phone number among the called phone number list; and transmitting the call transfer request message to the mobile communication server and requesting call transfer according to the call connection request signal.

According to another aspect of the present invention, there is provided a mobile terminal including: a radio frequency (RF) unit that is connected to a mobile communication server to transmit and receive a signal; and a controller that controls to convert, when a call connection request signal is received from the mobile communication server, a operation mode to a call transfer mode according to an input control signal, generate a call transfer request message including a selected phone number, and transmit the call transfer request message to the mobile communication server.

The mobile terminal may further include an input unit that receives the control signal for transferring a call when the call request signal is received and a memory unit that stores phonebook data including at least one phone number and a list of the at least one phone number.

### BRIEF DESCRIPTION OF THE DRAWINGS

FIG. 1 is a diagram illustrating a configuration of a call transfer service providing system according to an exemplary embodiment of the present invention;

FIG. 2 is a diagram illustrating a configuration of a mobile terminal according to an exemplary embodiment of the present invention;

FIG. is a flowchart illustrating a method of providing a call transfer service according to an exemplary embodiment of the present invention;

FIG. 4 is a flowchart illustrating a method of providing a call transfer service according to another exemplary embodiment of the present invention;

FIG. 5 is a flowchart illustrating an operation of a mobile terminal according to an exemplary embodiment of the present invention; and

FIG. 6 is a diagram illustrating an operation of a mobile terminal according to an exemplary embodiment of the present invention.

### BEST MODE FOR CARRYING OUT THE INVENTION

Exemplary embodiments of the present invention will be described in detail hereinafter with reference to the accompanying drawings.

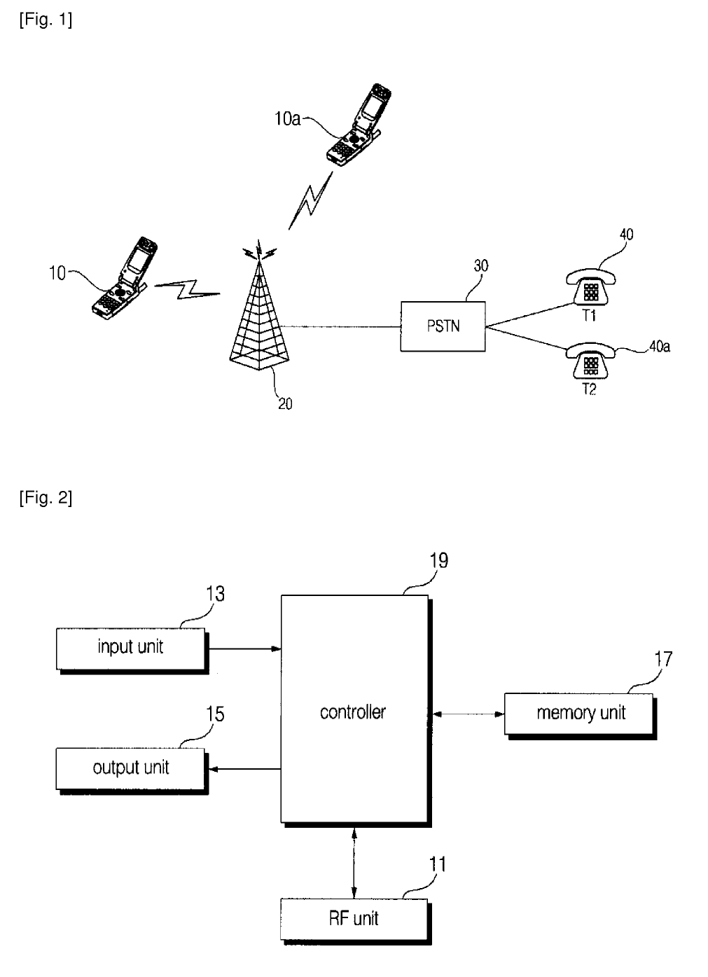

FIG. 1 is a diagram illustrating a network applied to a call transfer service providing system according to an exemplary embodiment of the present invention.

The network applied to the call transfer service providing system according to an exemplary embodiment of the present invention is embodied in a 4th generation mobile communication system and can connect a wire network and a mobile network by processing a signal transmitted and received between a mobile communication network and a public telephone network using an orthogonal frequency division multiplexing (hereinafter, referred to as ‘OFDM’ method.

Here, the OFDM method is a kind of digital modulation method used in radio communication and so on and divides high speed of data stream into low speed of several streams and simultaneously transmits the divided low speed of streams using a low transmission rate of several subcarriers. The method allows subcarriers to be overlapped on a frequency axis using orthogonality, and allows several subcarriers to be densely arranged not to interfere to each other even while being partially overlapped, thereby realizing broadband transmission that efficiently uses a narrow frequency range and improving a use efficiency of a frequency. Accordingly, a wired and wireless integration network can be constructed using the OFDM method.

Referring to FIG. 1, a network applied to the present invention includes a mobile terminal 10, a mobile communication server 20, a public switched telephone network (PSTN) 30, and a wire terminal 40. Here, the mobile communication server 20 transmits and receives a signal through a mobile communication network, and the PSTN 30 transmits and receives a signal through a public telephone network. In the present invention, as a signal transmitted and received between the mobile communication network and the public telephone network is modulated and transmitted in an OFDM method, as described above, a wire communication network and a mobile communication network can be connected to each other. In this case, the OFDM method is a generally used method and in the present invention, a detailed description thereof is omitted.

The mobile terminal 10 is a portable terminal having mobility that can transmit and receive data through a mobile communication network and may include, for example a mobile phone and a personal digital assistants (PDA). Further, the wire terminal 40 can perform wire communication by connecting to a public telephone network through a phone line connected to a phone exchange equipment and may include, for example a wired/wireless phone or a public phone that connects and uses a line in a home or a company.

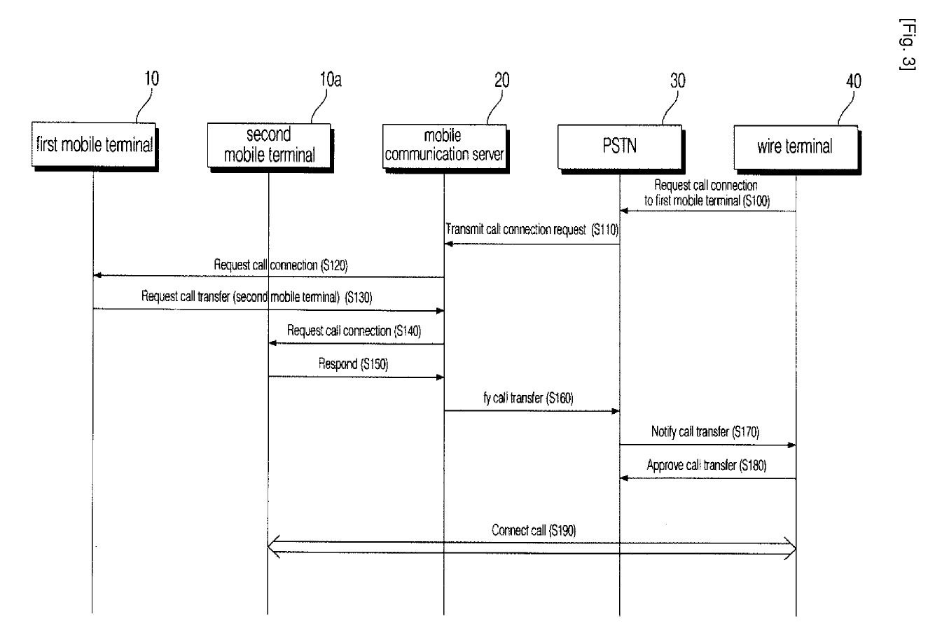

A configuration of the mobile terminal is described in detail with reference to FIG. 2.

FIG. 2 is a diagram illustrating a configuration of a mobile terminal according to an exemplary embodiment of the present invention.

Referring to FIG. 2, the mobile terminal 10 according to an exemplary embodiment of the present invention includes a RF unit 11, an input unit 13, an output unit 15, a memory unit 17, and a controller 19.

The RF unit 11 is connected to a mobile communication network to transmit and receive a signal. Here, the RF unit 11 includes a mobile communication module and transmits and receives a wireless signal to and from at least one of a base station, an external terminal, and a server through the mobile communication network. In this case, a wireless signal may include various forms of data according to a voice call signal, an audiovisual communication call signal, or message transmission and reception.

In the input unit 13, key input data for controlling an operation of the mobile terminal 10 are input. Here, the input unit 13 includes all means, in which a user can input predetermined data, such as a keypad and a touch pad having a plurality of key buttons.

The output unit 15 includes a display for outputting predetermined data on a screen and a speaker for outputting a sound signal. Here, the display displays information processed in the mobile terminal. Further, the speaker outputs a call signal reception sound, a message reception sound, and a sound signal related to a signal notifying event generation.

The memory unit 17 stores a program for processing and controlling the controller 19 and may perform a function of temporarily storing the input data.

The controller 19 generally controls operations of the units and controls general operations of the mobile terminal.

Further, when a call connection request is received through the RF unit 11, the controller 19 controls to convert an operation mode of the mobile terminal 10 to a call transfer mode according to an instruction that is input through the input unit 13 and at this time, calls phonebook data stored in the memory unit 17. Here, the phonebook data include a predetermined phone number of at least one of a mobile terminal and a wire terminal and a list of the stored predetermined phone numbers.

That is, the controller 19 controls to display the phone number list stored in the memory unit 17 on a display screen of the output unit 15 when calling phonebook data. In this case, when any one phone number of the displayed phone number list is selected, the controller 19 generates a call transfer request message including the selected phone number and transmits the message to the mobile communication server 20, thereby requesting call transfer to the another mobile terminal 10a or the wire terminal 40.

A call transfer service providing system having the above-described configuration is described in detail with reference to a flowchart.

FIG. 3 is a flowchart illustrating an operation of a method of providing a call transfer service according to an exemplary embodiment of the present invention and illustrates a call transfer operation between mobile terminals.

Referring to FIG. 3, when the wire terminal 40 transmits a call connection request signal to the first mobile terminal 10 (S100), the call connection request signal to the first mobile terminal 10 is transmitted from the PSTN 30 to the mobile communication server 20 via the mobile communication network (S110). In this case, the mobile communication server 20 detects the first mobile terminal 10 from a received signal and transmits the received signal to the first mobile terminal 10 (S120). In this case, the first mobile terminal 10 responds to a call request signal received from the mobile communication server 20 and thus a call is connected between the first mobile terminal 10 and the wire terminal 40.

When the first mobile terminal 10 intends to transfer a call to another mobile terminal i.e. the second mobile terminal 10a according to the received call request signal, the first mobile terminal 10 generates a call transfer request signal to the second mobile terminal 10a and transmits the signal to the mobile communication server 20 (S130).

When the first mobile terminal 10, having received the call request signal requests call transfer to the second mobile terminal 10a (S130), the mobile communication server 20 transmits a call connection request signal transmitted from the wire terminal 40 to the second mobile terminal 10a (S140). When the mobile communication server 20 receives a response signal of the call connection request signal from the second mobile terminal 10a (S150), the mobile communication server 20 transmits a signal notifying that a call is transferred to the second mobile terminal 10a to the PSTN 30 (S160). In this case, the PSTN 30 transmits the signal to the transmitting terminal i.e. the wire terminal 40 (S170).

As the wire terminal 40, having received a signal notifying that a call is transferred to the second mobile terminal 10a according to the call connection request signal approves the call transfer request (S180), a call is connected between the second mobile terminal 10a and the wire terminal 40 (S190) and thus communication can be performed between the second mobile terminal 10a and the wire terminal 40.

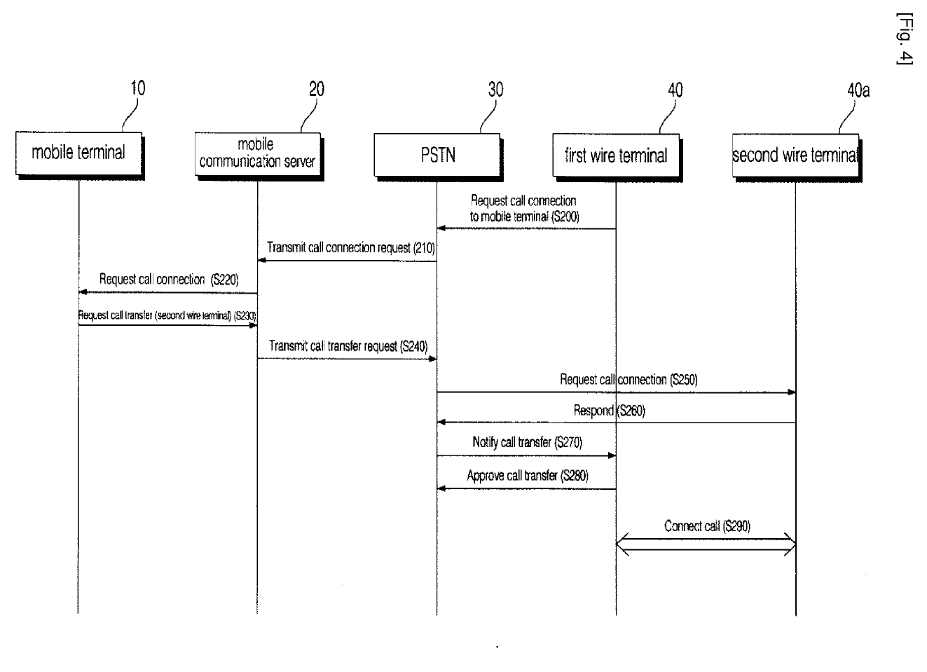

FIG. 4 is a flowchart illustrating an operation of a method of providing a call transfer service according to another exemplary embodiment of the present invention and illustrates an operation of transferring a call from a mobile terminal to another wire terminal.

Referring to FIG. 4, the first wire terminal 40 transmits a call connection request signal to the mobile terminal 10 (S200). In this case, the PSTN 30 transmits the call connection request signal to the mobile communication server 20 for managing a transmission and reception signal of the corresponding mobile terminal 10 through the mobile communication network (S210). Further, the mobile communication server 20 transmits a call connection request signal transmitted from the PSTN 30 to the mobile terminal 10 (S220). In this case, as the mobile terminal 10 responds to a call connection request signal received from the mobile communication server 20, a call is connected between the mobile terminal 10 and the first wire terminal 40.

When the mobile terminal 10 intends to transfer a call to another wire terminal i.e.

the second wire terminal 40a according to the received call request signal, the mobile terminal 10 generates a call transfer request signal to the second wire terminal 40a and transmits the signal to the mobile communication server 20 (S230).

In this case, the mobile communication server 20 transmits the call transfer request signal to the PSTN 30 for managing the second wire terminal 40a according to the call transfer request signal received from the mobile terminal 10 (S240). Further, the PSTN 30 transmits a call connection request signal transmitted from the first wire terminal 40 to the second wire terminal 40a according to the received call transfer request signal (S250).

The second wire terminal 40a transmits a response signal of the call connection request signal to the PSTN 30 (S260). In this case, when the PSTN 30 receives the response signal of a call connection request signal from the second wire terminal 40a, the PSTN 30 generates a signal notifying that the call connection request signal is transferred to the second wire terminal 40a and transmits the signal to the transmitting terminal i.e. the first wire terminal 40 (S270).

As the wire terminal 40, having received a signal notifying that a call is transferred to the second wire terminal 40a according to the call connection request signal approves the call transfer request (S280), a call is connected between the first wire terminal 40 and the second wire terminal 40a (S290) and thus communication can be performed between the first wire terminal 40 and the second wire terminal 40a.

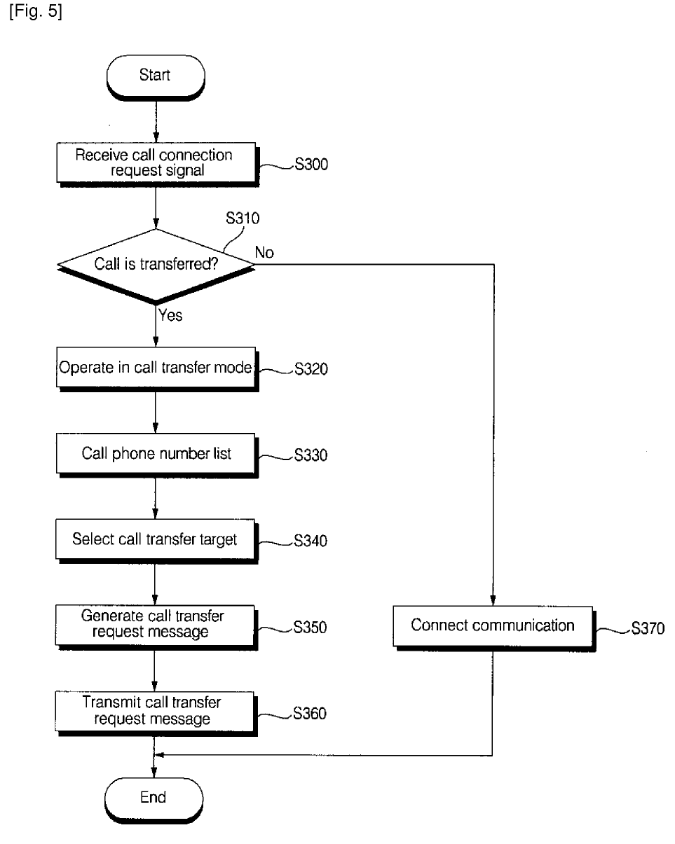

FIG. 5 is a flowchart illustrating an operation of a mobile terminal according to an exemplary embodiment of the present invention.

Referring to FIG. 5, when the mobile terminal 10 receives a call request signal from the mobile communication server 20 (S300), if a call transfer instruction is input through the input unit 13 (S310), the controller 19 controls the mobile terminal 10 to operate in a call transfer mode (S320).

In this case, the controller 19 calls phonebook data stored in the memory unit 17 and allows a phone number list to be displayed (S330). When any one phone number among a phone number list is selected by a key button manipulation of the input unit 13 (S340), the controller 19 generates a call transfer request message including the selected phone number (S350), and transmits the message to the mobile communication server 20 (S360), thereby transferring a call to the selected phone number according to the call connection request.

Therefore, in a system and a method for providing a call transfer service according to the present invention, even in a state where a call transfer service is not separately set, a user can use a call transfer service and dynamically select a call transfer target according to a situation.

When the mobile terminal 10 receives a call request signal from the mobile communication server 20 (S300), if a connection request signal is input through the input unit 13 (S310), the mobile terminal 10 can perform communication with the transmitting terminal by responding to the received call request signal (S370).

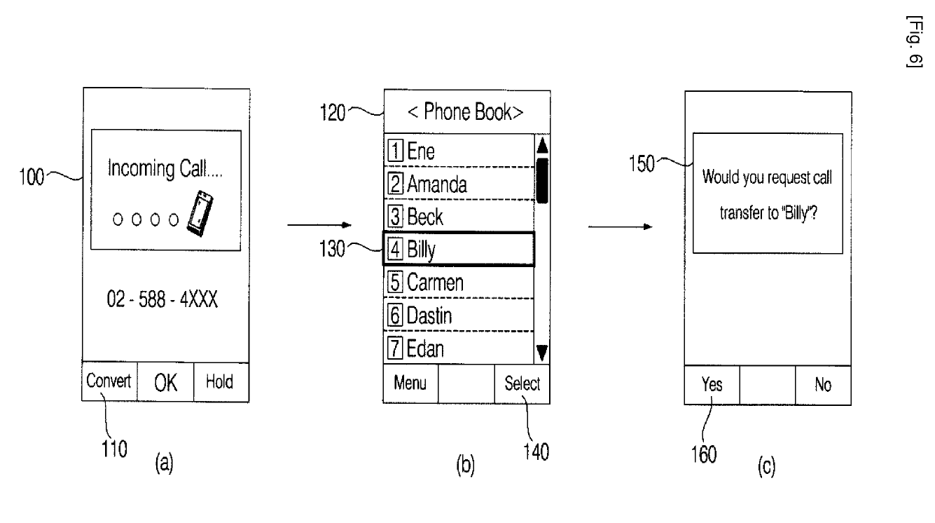

FIG. 6 is a diagram illustrating an operation of a mobile terminal according to an exemplary embodiment of the present invention.

First, FIG. 6(a) illustrates a display screen when a call connection request signal is received. When a call connection request signal is received, the controller 19 controls to display call connection information together with a call signal reception sound on the display screen 100. Here, the controller 19 controls to display a ‘conversion 110’ menu for converting an operating mode on the display screen 100 and convert an operating mode to a call transfer mode through the displayed ‘conversion 110’ menu.

In FIG. 6(a), when the ‘conversion 110’ menu is selected, as shown in FIG. 6(b), the controller calls phonebook data and controls to display the predetermined phone number list 120 on the display screen. In this case, by manipulating a ‘selection 140’ button, when ‘[4] : Billy 130’ is selected among a predetermined phone number list displayed on the display screen, the controller 19 controls to output a confirmation message 150, as shown in FIG. 6(c).

If a button for selecting ‘Yes 160’ is manipulated, the controller 19 controls to generate and transmit a call transfer request message including a phone number of the selected ‘[4] : Billy 130’ and thus transfer a call connection request signal to the corresponding phone number.

A method of providing a call transfer service and a mobile terminal using the same according to the present invention are described with reference to the drawings, however the present invention is not limited to exemplary embodiments described in the present specification and drawings and can be applied by one skilled in the art.

### INDUSTRIAL APPLICABILITY

In a method of providing a call transfer service and a mobile terminal using the same according to the present invention, when call connection is requested, it is selected whether a call is to be transferred, when a call is transferred, a phone number to transfer a call can be dynamically selected according to a user situation and thus user convenience according to call transfer can be improved.

1. A method of providing a call transfer service, comprising:
receiving, by a mobile communication server, a call connection request signal;
converting an operation mode to a call transfer mode and calling a stored predetermined phone number list;
generating a call transfer request message including a selected phone number among the called phone number list; and
transmitting the call transfer request message to the mobile communication server and requesting call transfer according to the call connection request signal.

2. The method of claim 1, wherein the call connection request signal is a signal transmitted from a public switched telephone network (PSTN) connected to at least one wire terminal.

3. The method of claim 1, wherein the selected phone number is a phone number of any one of a mobile terminal and a wire terminal.

4. The method of claim 1, further comprising receiving, by the mobile communication server, the call transfer request message.

5. The method of claim 4, further comprising transmitting, when the call transfer request message is a message for requesting call transfer to another mobile terminal, a call connection request signal to another mobile terminal based on a phone number included in the call transfer request message.

6. The method of claim 5, further comprising:
transmitting, by the another mobile terminal, a response signal of the call connection request signal to the mobile communication server; and
transmitting, by the mobile communication server, a signal notifying that a call is transferred to the another mobile terminal to a transmitting terminal through a PSTN.

7. The method of claim 4, further comprising transmitting, when the call transfer request message is a message for requesting call transfer to another mobile terminal, a call transfer request message to the PSTN.

8. The method of claim 7, further comprising transmitting, by the PSTN, a call connection request signal to the another wire terminal based on a phone number included in the call transfer request message.

9. The method of claim 8, further comprising:
transmitting, by the another wire terminal, a response signal of the call connection request signal to the PSTN; and
transmitting, by the PSTN, a signal notifying that a call is transferred to the another wire terminal to a transmitting terminal.

10. The method of claim 1, further comprising connecting a call between a terminal corresponding to the selected phone number and a transmitting terminal, having transmitted the call connection request signal.

11. A mobile terminal comprising:
a radio frequency (RF) unit, which is connected to a mobile server and transmits signals to or receives signals from the mobile server; and
a controller that controls to convert, when a call connection request signal is received from the mobile communication server, a operation mode to a call transfer mode according to an input control signal, generate a call transfer request message including a selected phone number, and transmit the call transfer request message to the mobile communication server.

12. The mobile terminal of claim 11, wherein the call connection request signal is a signal transmitted from a PSTN that is connected to at least one wire terminal to process a call signal of the wire terminal.

13. The mobile terminal of claim 11, wherein the controller provides, when the call connection request signal is received, a conversion menu for converting an operating mode and controls to convert an operating mode to a call transfer mode through the conversion menu.

14. The mobile terminal of claim 11, further comprising an input unit that receives the control signal for transferring a call when the call request signal is received.

15. The mobile terminal of claim 11, further comprising a memory unit that stores phonebook data including at least one phone number and a list of the at least one phone number.

16. The mobile terminal of claim 15, wherein the controller calls, when converting an operation mode to a call transfer mode, the phonebook data stored in the memory unit and selects any one phone number of the list of at least one phone number.
